(19) United States
(12) Patent Application Publication
(10) Pub. No.: US 2025/0122007 A1
(43) Pub. Date: Apr. 17, 2025

(54) MODULAR CARTRIDGE WASTE COLLECTION SYSTEM

(71) Applicant: Rehrig Pacific Company, Los Angeles, CA (US)

(72) Inventors: Derick Foster, Cumming, GA (US); Daniel Vincent Sekowski, Loganville, GA (US); Derek Gravitt, Buford, GA (US); John Matthew Thomson, Dahlonega, GA (US)

(21) Appl. No.: 18/918,557

(22) Filed: Oct. 17, 2024

Related U.S. Application Data
(60) Provisional application No. 63/544,619, filed on Oct. 17, 2023.

(51) Int. Cl. B65F 1/00; B65F 1/14; B65F 1/16

(52) U.S. Cl. CPC B65F 1/0066; B65F 1/1473; B65F 1/1615; B65F 2001/0086; B65F 2001/1653

(57) ABSTRACT

A waste collection system includes a base defining a plurality of bays. A pair of tine openings are defined in the base. A plurality of container bodies are each receivable in one of the plurality of bays, such that the plurality of container bodies would be emptied when the base is inverted.

### BACKGROUND

Commercial containers (dumpsters) are often placed at office, commercial, restaurant, or other large facilities. A large amount of waste material can be easily collected by a suitable collection vehicle, typically including fork tines that are inserted into tine-receiving openings on the commercial container. The tines lift and then invert the commercial container to transfer the waste contents to the collection vehicle.

However, placing the waste into the commercial container by the users (e.g. maintenance staff) is not as easy. The waste is often transferred from one smaller container to the commercial container and may need to be lifted over the top of the commercial container or through an opening in the side. This is made even more difficult by heavy waste, such as organic material.

Additionally, different types of waste may need to be separated, such as into recyclables, organic material, and trash. This separation is not provided by a single large commercial container.

### SUMMARY

A waste collection system disclosed herein includes a base defining a plurality of bays. A pair of tine openings are defined in the base. Each of a plurality of container bodies is receivable in one of the plurality of bays, such that the plurality of container bodies would be emptied when the base is inverted.

Each container body may be part of a cartridge that includes a plurality of wheels supporting the container body and a lid selectively closing the cartridge. Each cartridge can be loaded with waste in the associated facility and the rolled into place in the base for collection. Each cartridge may include interlocking portions that interlock with complementary interlocking portions on the base. The interlocking portions permit the base and cartridges to be lifted together and inverted by standard tines on a standard collection vehicle.

This eliminates the need to move the waste from smaller containers into a large commercial container. Also, in some embodiments, the cartridges could each contain different types of waste.

### BRIEF DESCRIPTION OF THE DRAWINGS

FIG. 1 is a perspective view of a commercial container cartridge system.

FIG. 2 shows the commercial container cartridge system of FIG. 1 with the cartridges in the bays.

FIG. 3 is a rear perspective view of the commercial container cartridge system of FIG. 2.

FIG. 4 is a front perspective view of the base of FIG. 1, without the cartridges.

FIG. 5 is a rear perspective view of the base of FIG. 4.

FIG. 6 is a front view of the base of FIG. 4.

FIG. 7 is a side view of one of the outer panels of FIG. 1.

FIG. 8 is a perspective view of the outer panel of FIG. 7.

FIG. 9 is a front view of the outer panel of FIG. 7.

FIG. 10 is a side view of one of the inner panels of FIG. 1.

FIG. 11 is a perspective view of the inner panel of FIG. 10.

FIG. 12 is a front view of the inner panel of FIG. 10.

FIG. 13 shows the inner and outer panels of FIG. 1 in an unassembled state arranged for shipping.

FIG. 14 shows the complete base in an unassembled configuration for shipping.

FIG. 15 is a front perspective view of one of the cartridges.

FIG. 16 is a side view of the cartridge of FIG. 15.

FIG. 17 is a front view of the cartridge of FIG. 15.

FIG. 18 is a front perspective view of the cartridge of FIG. 15 with the sub-lid open.

FIG. 19 is a front perspective view of the cartridge of FIG. 15 with the main lid open.

FIG. 20 shows the commercial container cartridge system of FIG. 2 with the lock bar pivoted downward.

FIG. 21 shows one of the cartridges being slid into one of the bays of the base of the commercial container cartridge system of FIG. 1.

FIG. 22 shows an alternative cartridge with a gravity lock.

### DETAILED DESCRIPTION

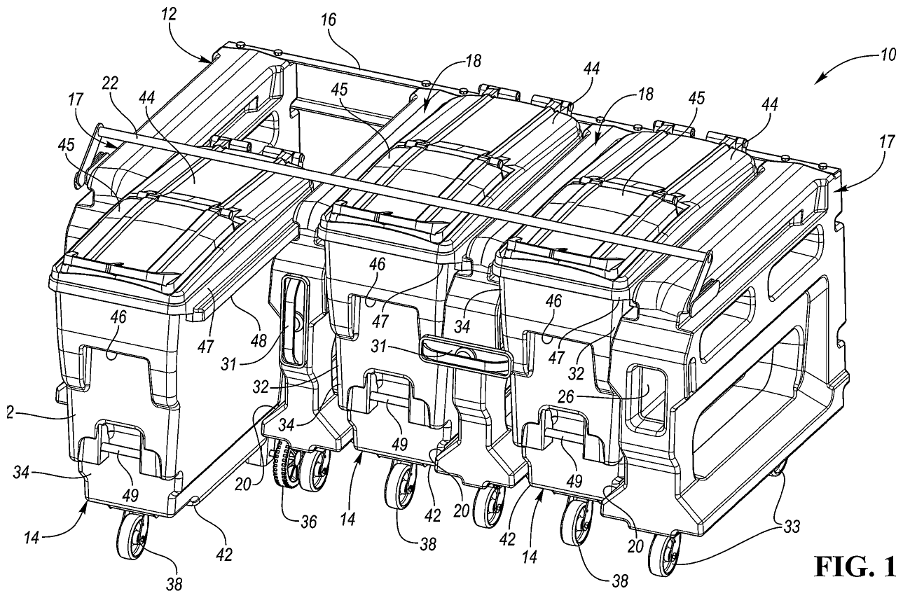

A front perspective view of a commercial container cartridge system 10 is shown in FIG. 1. The commercial container cartridge system 10 is modular, as will be explained below and includes a base 12 and a plurality of cartridges 14 (in this example, three are shown in FIG. 1). The base 12 includes a metal frame, which in this example includes a at least one connector bar, and more specifically in this example, a plurality of metal bars 16 (only one visible in FIG. 1) such as metal C-channel bars, but other reinforcement could also be used, such as metal tubes.

The base 12 includes a plurality of spaced-apart panels, including a pair of outer panels 17 and a plurality of inner panels 18 (two in this example) connected at the rear of the base 12 by the plurality of metal bars 16. Each of the outer panels 17 and inner panels 18 may be formed as a single piece of plastic, such as by rotomolding. The outer panels 17 are identical to one another. The inner panels 18 are identical to one another and are spaced apart from one another. The inner panels 18 are spaced apart between the outer panels 17.

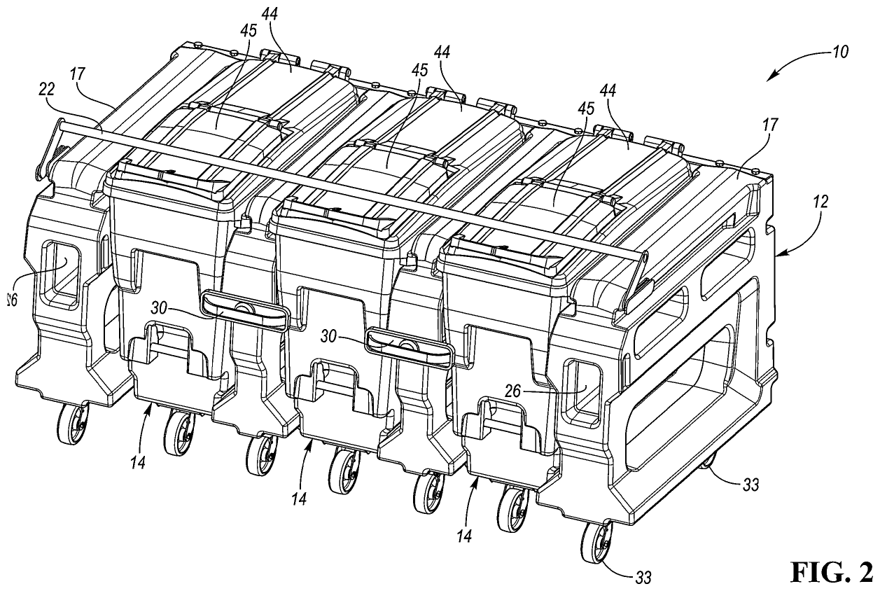

The base 12 defines a plurality of bays 20 (in this example, three, but two or four bays could also be used) between the inner panels 18, and between the inner panels 18 and the outer panels 17. Each of the outer panels 17 has a tine-receiving opening 26 formed therein (also see FIG. 2). The tine-receiving openings 26 are sized and positioned to receive the tines of a standard waste-collection truck having standard tines for lifting and inverting commercial containers (dumpsters). For example, the distance between the inner surfaces of the tine openings may be approximately six feet.

A gravity lock bar 22 is pivotably secured to the outer panels 17 and extends over the bays 20. In FIG. 1, the gravity lock bar 22 is shown in a locked position on top of the main lids 44 of the cartridges 14. The gravity lock bar 22 can pivot forward and downward to an unlocked position in front of the bays 20.

A latch 31 is rotatably attached to a front edge of each of the inner panels 18. One latch 31 is shown in the closed position in FIG. 1 over one and a half of the front openings to the bays 20. The latch 31 may be molded plastic and may be formed of a color contrasting with that of the inner panels 18 so that it is clear whether the latches 31 are latched. Other visual indicators can be provided.

The other latch 31 is shown in the open position such that one of the cartridges 14, can be partially removed from the bay 20 (as shown). Wheels 33 support outer panels 17 at the corners of the base 12.

Each cartridge 14 includes a container body 34 supported by a plurality of wheels, such as rear wheels 36 and a front caster 38 with a wheel pivotable about a vertical axis for steering. The container body 34 includes a side wall 32 extending upward from a base wall 42. The side wall 32 defines an upper opening to the container body 34,

A main lid 44 is hingeably secured to a rear end of the container body 34. A sub-lid 45 selectively covers a smaller opening through the main lid 44. An upper attachment envelope 46 projects from a front end of the container body 34, spaced above a grab bar 49, both of which can be used by standard semi-automated lift equipment. The container body 34 includes a lip 47 projecting outward and downward from an upper edge of the side wall 32 about the periphery of the container body 34. A secondary lip 48 projects outward from the lip 47 along the side edges of the container body 34.

As can be seen in FIG. 1, the main lids 44 are higher than the base 12. The uppermost edges of the container bodies 34 may also be at the same or greater height as the base 12. This helps keep the base 12 clean when the commercial container cartridge system 10 is inverted and the cartridges 14 are emptied.

FIG. 2 shows the commercial container cartridge system 10 of FIG. 1 with all the cartridges 14 in the bays 20 and the latches 31 latched.

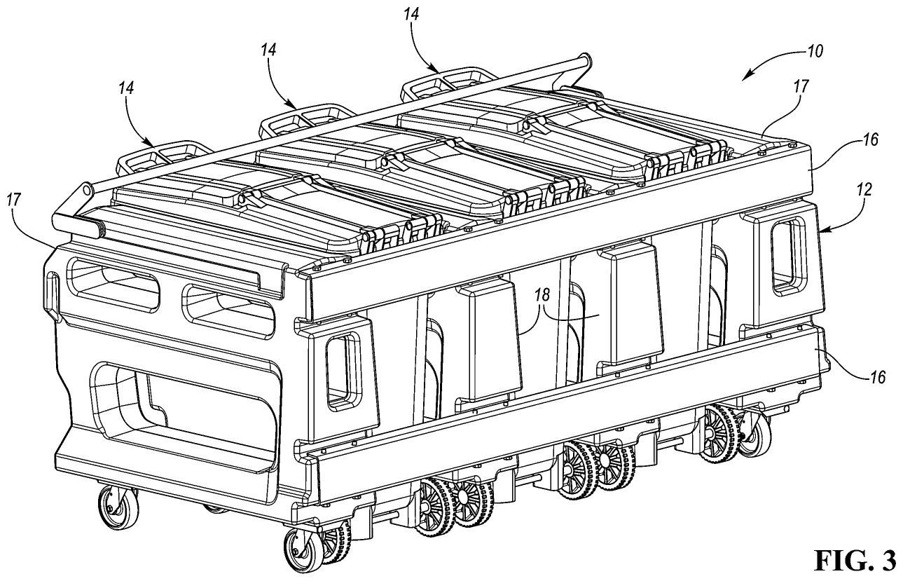

FIG. 3 is a rear perspective view of the commercial container cartridge system 10 of FIG. 1, with all the cartridges 14 received in the base 12. The plurality of metal bars 16 (two in this example) are C-channels that receive therein projections molded on the rear ends of the outer panels 17 and inner panels 18. The metal bars 16 may be secured to each of the outer panels 17 and the inner panels 18, such as by fasteners, such as by a screw or bolt securing each of the metal bars 16 to each of the outer panels 17 and the inner panels 18.

As shown on one of the inner panels 18, a metal plate 40 may be insert-molded within the back wall of the inner panel 18. The metal plate 40 is then secured to the metal bar 16 by a bolt or screw or other fastener. Such a metal plate 40 may be insert molded in position adjacent each metal bar 16 on the back wall of the inner panels 18 and the outer panels 17. Alternatively, a single large metal plate could be insert molded at each back wall and connected to all of the metal bars 16.

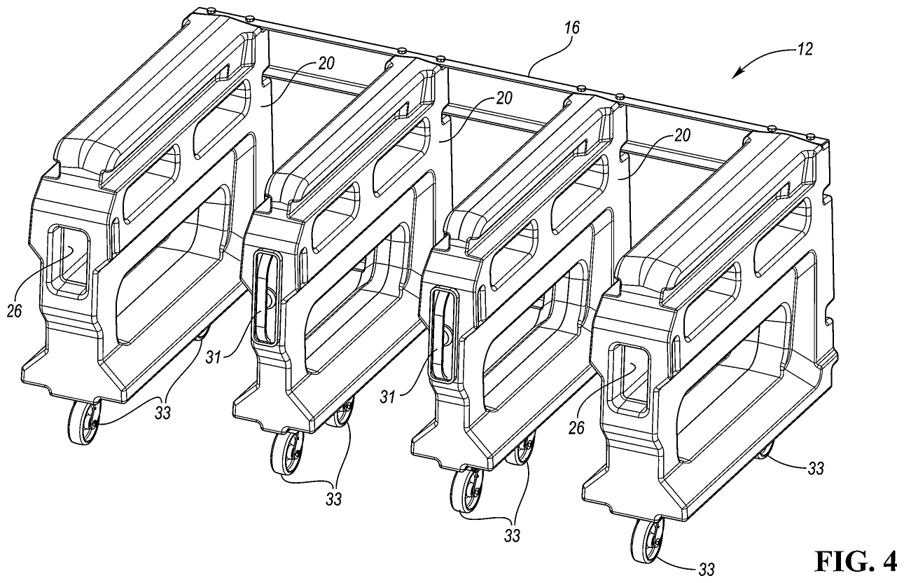

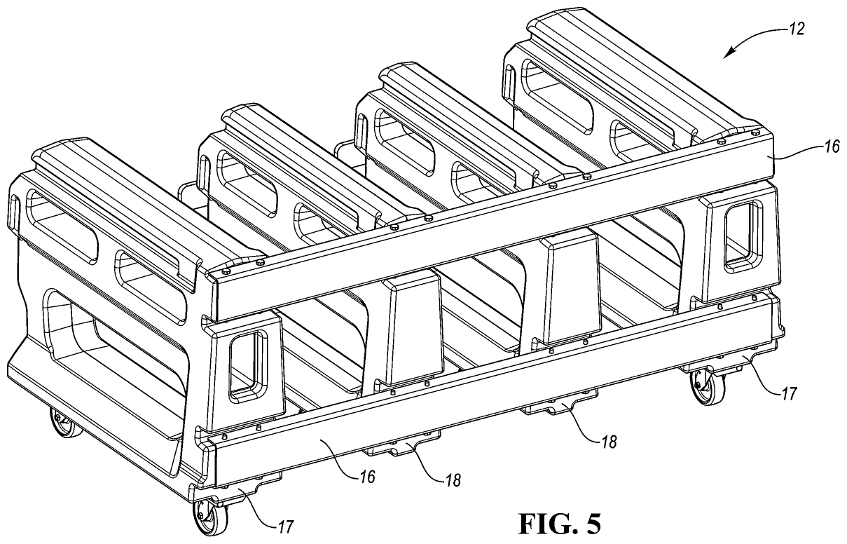

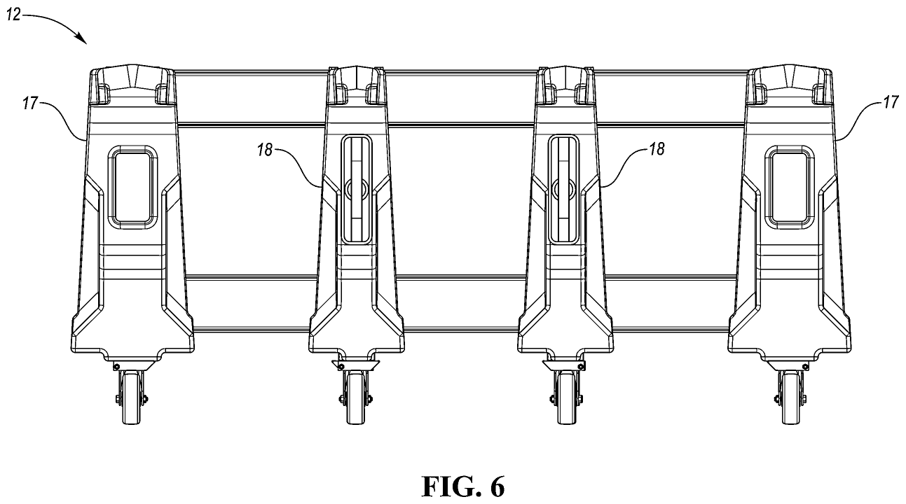

FIG. 4 is a front perspective view of the base 12 of FIG. 1, without the cartridges 14. FIG. 5 is a rear perspective view of the base 12 of FIG. 4. FIG. 6 is a front view of the base 12 of FIG. 4.

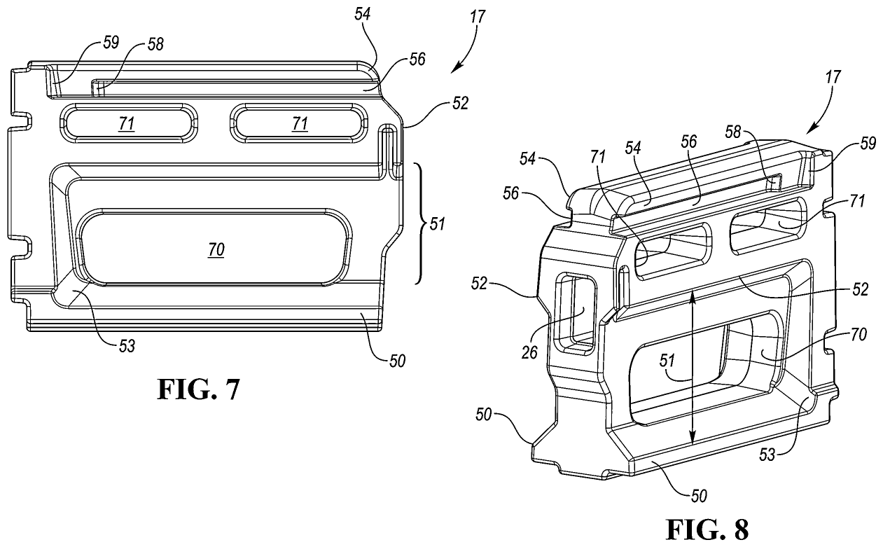

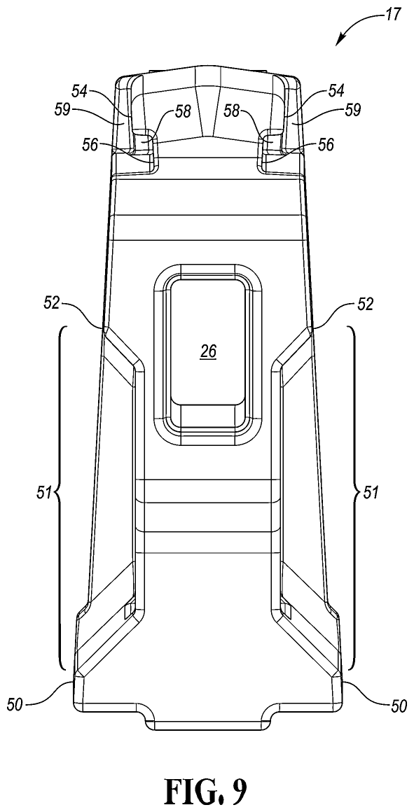

FIG. 7 is a side view of one of the outer panels 17. The other side of the outer panel 17 is mirror image and all the outer panels 17 are identical, such that they can be formed in the same mold. FIG. 8 is a perspective view of the outer panel 17. FIG. 9 is a front view of the outer panel 17.

Referring to FIGS. 7-9, the outer panel 17 includes a flared base or lower flared portion 50 (when considering a section through the outer panel 17 perpendicular to the side faces). A narrowed portion 51 of the outer panel 17 is above the lower flared portion 50 and defined below an intermediate flared portion 52. Spaced above the intermediate flared portion 52 is an upper flared portion 54, such that an upper groove 56 is defined between the intermediate flared portion 52 and the upper flared portion 54. The upper flared portion 54 projects outward less than the intermediate flared portion 52. The intermediate flared portion 52 projects outward less than the lower flared portion 50.

A stop 53 is formed near the rear end of the outer panel 17 above the lower flared portion 50. Another stop 58 is formed at rear end of the upper groove 56. A third stop 59 is formed at a rear end of the outer panel 17, above the intermediate flared portion 52 and extending outward of the upper flared portion 54. The third stop 59 is formed rearward of the stop 58. A plurality of projections and recesses are formed on the rear end of the outer panel 17 for receiving the plurality of metal bars 16.

A large opening 70 is formed through the narrowed portion 51, within inner walls extending from one side of the outer panel 17 to the other. A pair of smaller openings 71 are formed through the outer panel 17 below the upper groove 56 and above the intermediate flared portion 52. The large opening 70 and the pair of smaller openings 71 reduce the weight of the outer panel 17 and increase its rigidity. The upper groove 56, intermediate flared portion 52, and upper flared portion 54 are interlocking portions for interlocking with the cartridges 14.

As can be seen in FIG. 9, the overall width of the outer panel 17 tapers downward from the lower end to the upper end, i.e. the upper end is narrower than the lower end.

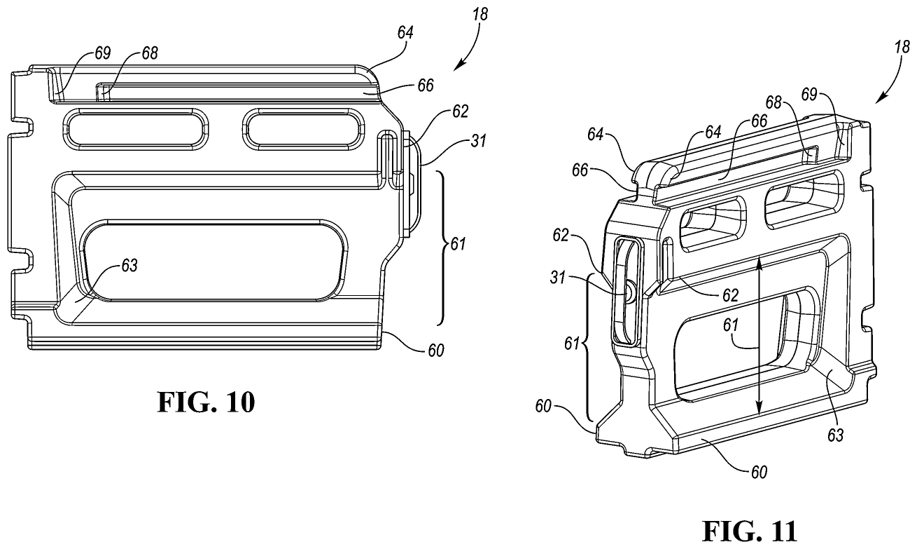

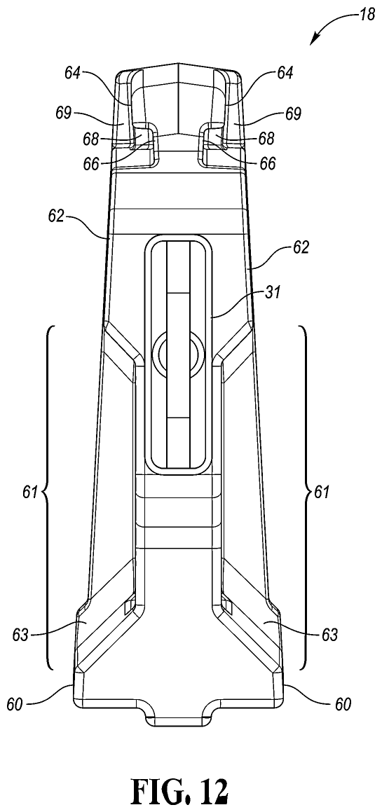

FIG. 10 is a side view of one of the inner panels 18. The other side of the inner panel 18 is mirror image and all the inner panels 18 are identical, such that they can be formed in the same mold. FIG. 11 is a perspective view of the inner panel 18. FIG. 12 is a front view of the inner panel 18.

Referring to FIGS. 10-12, the inner panel 18 includes a flared base or lower flared portion 60 (when considering a section through the inner panel 18 perpendicular to the side faces). A narrowed portion 61 of the inner panel 18 is above the lower flared portion 60 and defined below an intermediate flared portion 62. Spaced above the intermediate flared portion 62 is an upper flared portion 64, such that an upper groove 66 is defined between the intermediate flared portion 62 and the upper flared portion 64. The upper flared portion 64 projects outward less than the intermediate flared portion 62. The intermediate flared portion 62 projects outward less than the lower flared portion 60.

A stop 63 is formed near the rear end of the inner panel 18 above the lower flared portion 60. Another stop 68 is formed at rear end of the upper groove 66. A third stop 69 is formed at a rear end of the inner panel 18, above the intermediate flared portion 62 and extending outward of the upper flared portion 64. The third stop 69 is formed rearward of the stop 68. A plurality of projections and recesses are formed on the rear end of the inner panel 18 for receiving the plurality of metal bars 16.

A large opening is formed through the narrowed portion 61, within inner walls extending from one side of the inner panel 18 to the other. A pair of smaller openings are formed through the inner panel 18 below the upper groove 66 and above the intermediate flared portion 62. The large opening and the pair of smaller openings reduce the weight of the inner panel 18 and increase its rigidity. The upper groove 66, intermediate flared portion 62, and upper flared portion 64 are interlocking portions for interlocking with the cartridges 14.

As can be seen in FIG. 12, the overall width of the inner panel 18 tapers downward from the lower end to the upper end, i.e. the upper end is narrower than the lower end.

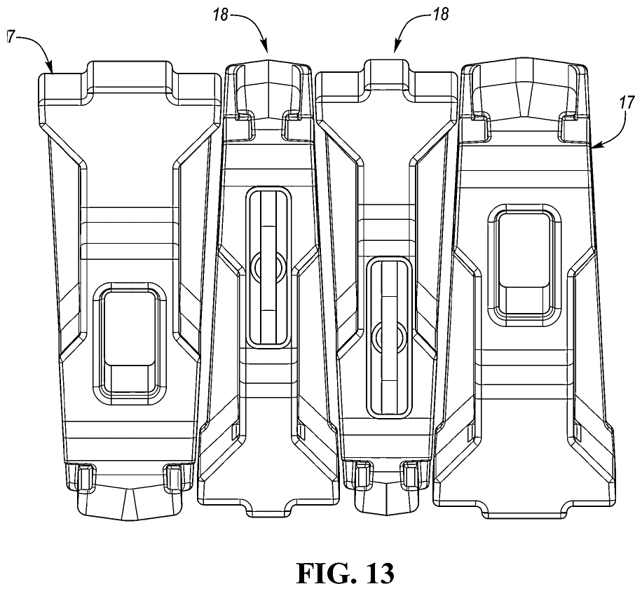

Referring to FIG. 13, during shipping in an unassembled state, the outer panels 17 and the inner panels 18 can be positioned next to one another in alternating orientations such that the narrow upper end of one abuts the wider lower end of the next.

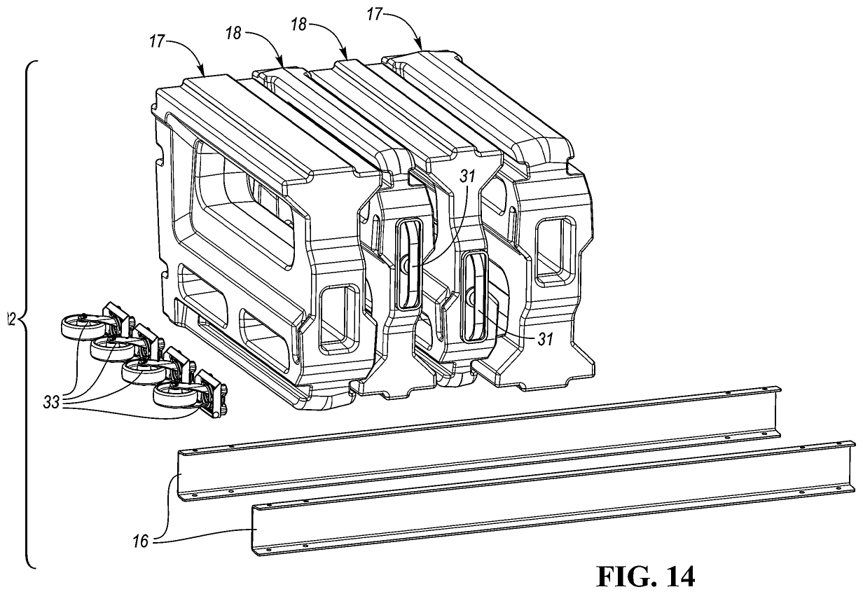

FIG. 14 shows the complete base 12 in an unassembled configuration for shipping. The base 12 occupies significantly reduced volume when unassembled and significantly less than if the base 12 were formed as a single structure. The base 12 can easily be assembled on site or near site with minimal, basic tools.

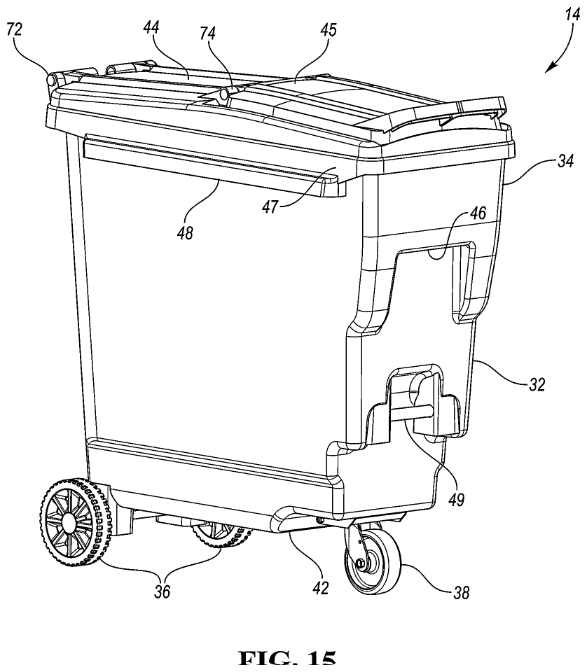

FIG. 15 shows one of the cartridges 14. In this example, the cartridges 14 are identical, but they could be different sizes from one another. The cartridge 14 includes the container body 34, which is the side wall 32 extending upward from the base wall 42. The container body 34 includes the lip 47 projecting outward and downward from the upper edge of the side wall 32 about the periphery of the container body 34. The secondary lip 48 projects outward from the lip 47 along the side edges of the container body 34. The container body 34, including the side wall 32, base wall 42, upper attachment envelope 46, lip 47, and secondary lip 48 may all be integrally molded as a single piece of plastic, such as via injection molding. The rear wheels 36 and the front caster 38 are mounted to the base wall 42.

The upper attachment envelope 46 and grab bar 49 permit the cartridges 14 to be lifted and emptied by standard semi-automated lift equipment, if necessary.

The cartridges 14 are preferably (but not necessarily) significantly narrower (side to side) than they are long (front to back). In the example shown, the cartridge 14 is more than twice as long (front to back) as it is wide (side to side).

The main lid 44 is hingeably secured to a rear end of the container body 34 via a hinge 72. Optionally, a latch (not illustrated) opposite the hinge 72 may keep the main lid 44 in the closed position over the opening to the container body 34 until released manually or otherwise.

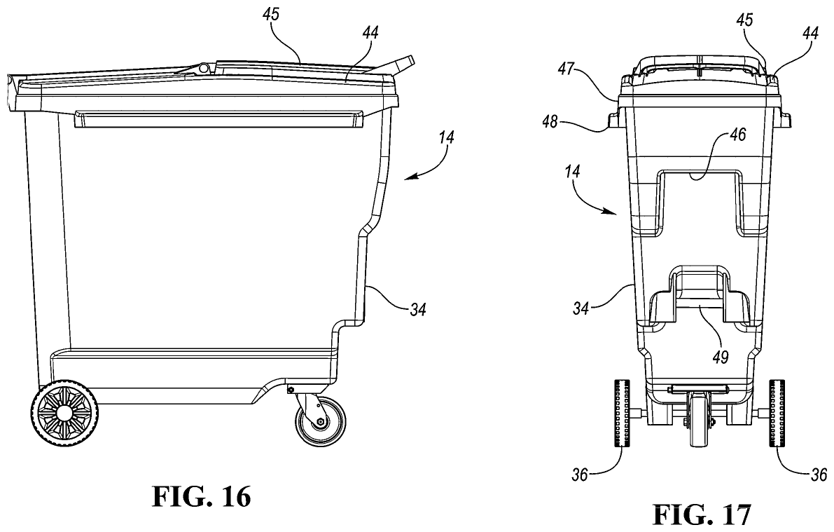

As shown in FIGS. 16 and 17, the main lid 44 is retained on top of the lip 47 and may be slightly recessed from the outer periphery of the lip 47. The secondary lip 48 and rear wheels 36 are positioned outwardly of the container body 34 and may be considered interlocking portions for interlocking with the base 12 to retain the cartridges 14 in the base 12 when inverted.

The sub-lid 45 is hingeably connected to the main lid 44 via a hinge 74 along a side edge of the container body 34. Again, a latch (not illustrated) opposite the hinge 74 optionally retains the sub-lid 45 in the closed position over the opening through the main lid 44 until released manually.

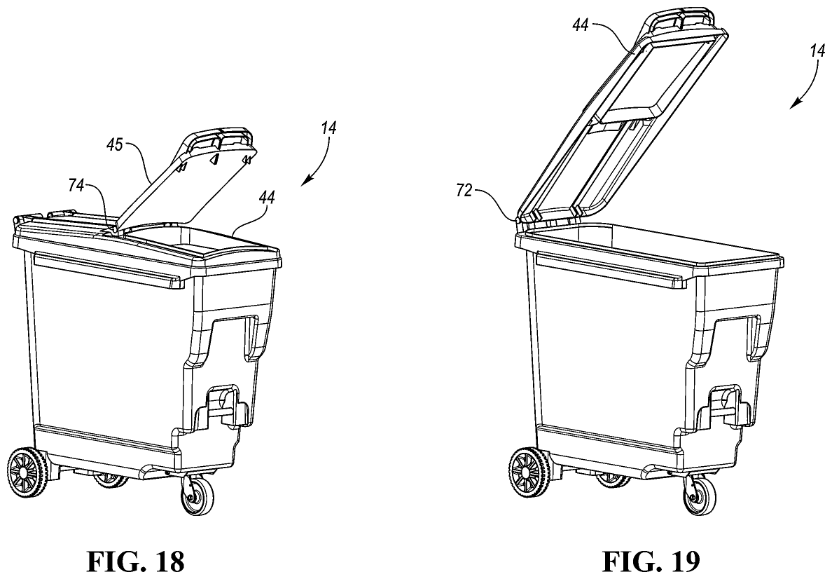

As shown in FIG. 18, when the cartridge 14 is positioned to be filled by users, the users can open the sub-lid 45 (again, optionally by releasing a latch) and place waste, recycling or organic waste, etc, in the container body 34, as appropriate. The sub-lid 45 is easier to open than the main lid 44. However, as shown in FIG. 19, if necessary, the main lid 44 can be opened (after releasing the optional latch).

In use, at a particular facility, such as a business (such as a restaurant or office), or a school, etc., each of the plurality of cartridges 14 may be assigned to a different use. For example, one cartridge 14 may be assigned to waste, another to recycling, and another to organic material. The cartridges 14 may be labeled appropriately. Alternatively, they can all be used for the same type of use. Each of the cartridges 14 may be positioned in different parts of the facility, as needed.

Alternatively, the facility may have more cartridges 14 than bays 20 available in the base 12. For example, the facility may have three cartridges 14 for waste, three for recycling, and three for organic material. The appropriate set of cartridges 14 would be positioned in the base 12 just prior to the pickup of the corresponding material (e.g. waste, recycling, organics). The cartridges 14 are removed after being emptied and replaced with the cartridges 14 to be emptied on the next pickup day, and so on.

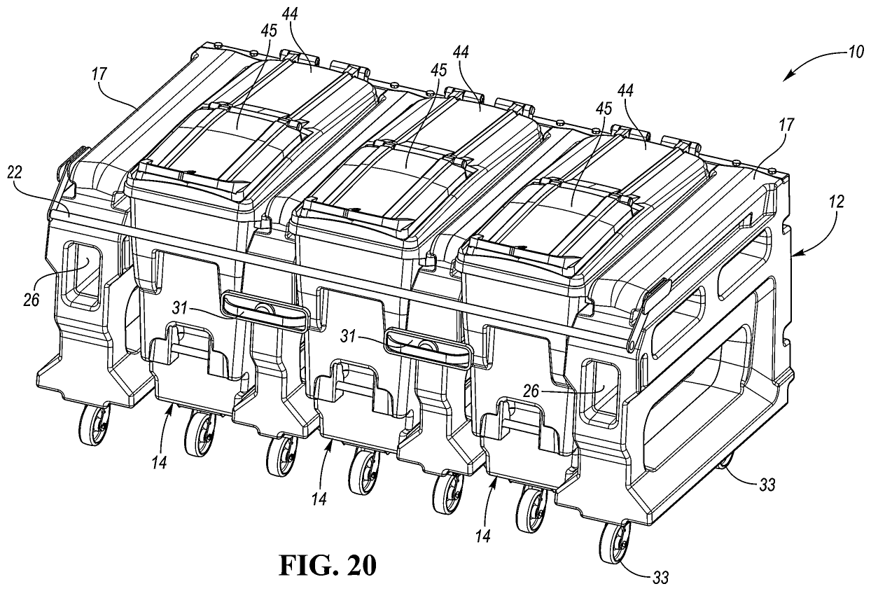

FIG. 20 shows the cartridges 14 loaded into the base 12 and the latches 31 closed. The tines of a collection vehicle are inserted into the tine-receiving opening 26 of the outer panels 17. The latches of the sub-lids 45 (if any) are latched. The latches of the main lids 44 (if any) are manually released. The tines then lift the commercial container cartridge system 10 and invert it (as it would a commercial container or dumpster) into a collection receptacle. The rear wheels 36 interlock below the lower flared portions 60 of the inner panels 18 and below the lower flared portions 50 of the outer panels 17 and the secondary lips 48 interlock in the upper grooves 56 of the outer panels 17 and the upper grooves 66 of the inner panels 18 to retain the cartridges 14 in the base 12 while inverted.

During inversion, the gravity lock bar 22 pivots forward away from the main lids 44 to a position adjacent front walls of the cartridges 14 as shown. This permits the main lids 44 to pivot open. The main lids 44 pivot open under the weight of the contents and the cartridges 14 are emptied. The commercial container cartridge system 10 is then returned to its place and the empty cartridges 14 can be used again.

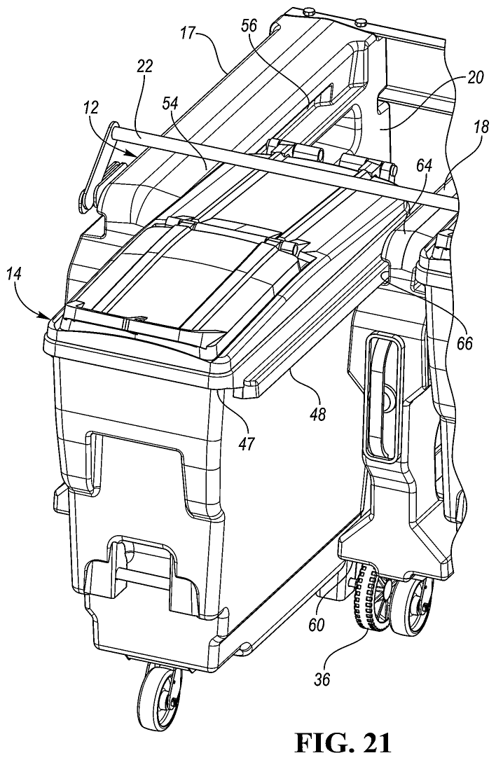

FIG. 21 shows one of the cartridges 14 being rolled into one of the bays 20 of the base 12. The secondary lip 48 is received in the upper groove 66 of the inner panel 18 (and would be received in the upper groove 56 of the outer panel 17). The rear wheels 36 are received below the lower flared portion 60 of the inner panel 18 (and below the lower flared portion 50 of the outer panel 17). The cartridge 14 is slid back into the bay 20 until the lip 47 contacts the third stops 59, 69, the secondary lip 48 contacts the stops 58, 68, and the container body 34 contacts the stops 53, 63. The weight of the gravity lock bar 22 keeps the main lids 44 and sub-lids 45 closed.

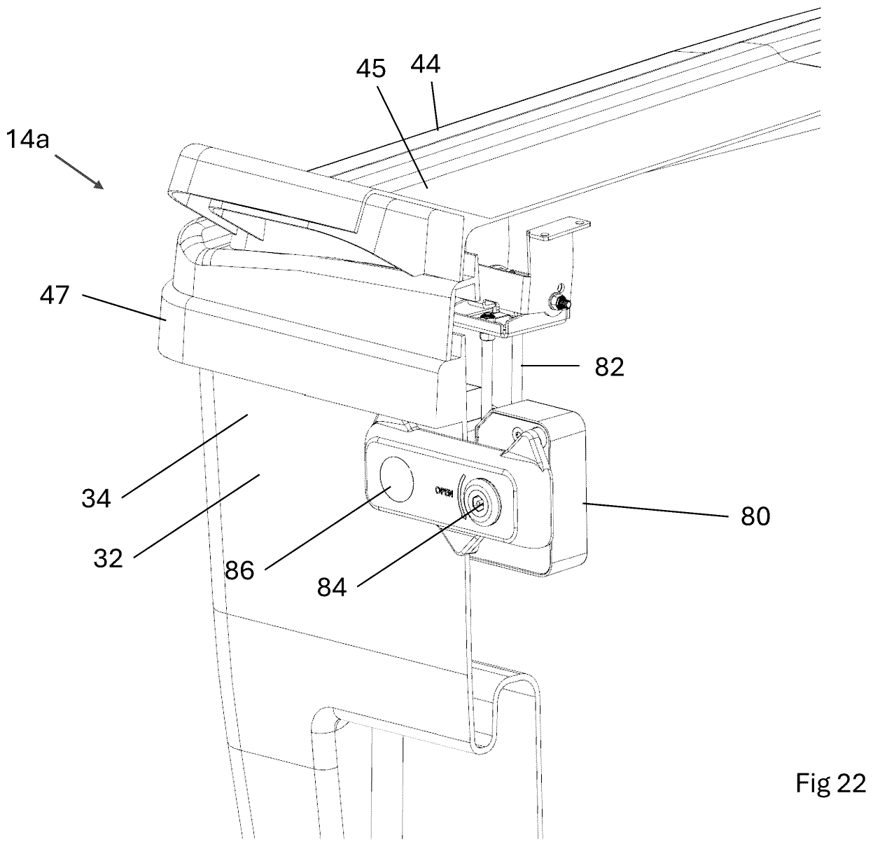

FIG. 22 shows an alternative cartridge 14a with a gravity lock. The cartridge 14a is identical to the cartridge 14 of FIG. 15, with the addition of a gravity lock 80 secured to a front portion of the side wall 32 of the container body 34. The gravity lock 80 receives a loop 82 that is secured to a front portion of the sub-lid 45. Note that latching the sub-lid 45 to the container body 34 also keeps the main lid 44 closed.

A key engaging a keyway 84 selectively changes the gravity lock 80 between a locked and unlocked condition. However, even when locked, the gravity lock 80 will release when inverted so that the main lid will open and the contents of the alternative cartridge 14a will be dumped when inverted. Such gravity locks are known.

Alternatively, each of the cartridges 14a includes a gravity lock 80 that includes a wireless actuator 86 for actuating the latch, such as by RFID, wi-fi, RF, Bluetooth, or other wireless signal from the collection vehicle. In one embodiment, the locks 80 will still release when inverted. However, as another alternative, the locks 80 will only release when inverted if the associated wireless actuator 86 has also been activated. In this embodiment, at least some of the cartridges 14a contain a different type of material and then the cartridges 14a can have locks 80 that are configured to be released only upon receiving the correct wireless signal. The rest remain latched. Therefore, for example, when the recycling collection vehicle lifts the commercial container cartridge system 10, it sends a wireless signal to the cartridges 14a that releases only the latches for cartridges 14a that contain recycling. The cartridges 14a containing waste or organics remain latched and are not emptied at that time. When the commercial container cartridge system 10 is inverted, only the main lid 44 of the cartridge(s) 14a containing recycling pivot open and release their contents. The other main lids 44 remain closed and retain their contents. The commercial container cartridge system 10 is returned to place. Another collection vehicle repeats the process with a different wireless signal that releases the waste or organics cartridges 14a.

The base 12 can be reconfigured to have a different number of inner panels 18 and bays 20. For example, with a single inner panel 18, the commercial container cartridge system 10 would have two larger bays to accommodate two larger cartridges (not pictured). Alternatively, bays having different sizes from one another could be provided (i.e. one large bay and one smaller bay).

As another option, a “mud flap” may be positioned at the front of the base 12. A beam may extend across the front of the base 12, with a flap extending down therefrom such that the cartridges 14 can be pushed through the flap and such that the flap covers the handles of the cartridges 14 when the cartridges 14 are in position. This would help keep the handles clean.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A waste collection system comprising:
a base defining a plurality of bays, a pair of tine openings defined in the base; and
a plurality of container bodies each receivable in one of the plurality of bays, such that the plurality of container bodies would be emptied when the base is inverted.

2. The waste collection system of claim 1 wherein the plurality of container bodies are configured to interlock with the base.

3. The waste collection system of claim 1 wherein the base includes a plurality of spaced-apart panels defining the plurality of bays therebetween.

4. The waste collection system of claim 3 wherein the plurality of spaced-apart panels includes a pair of outer panels in which the pair of tine openings are defined.

5. The waste collection system of claim 4 wherein the plurality of spaced-apart panels includes a pair of inner panels between the pair of outer panels.

6. The waste collection system of claim 5 further including at least one metal bar connecting the pair of outer panels to the pair of inner panels.

7. The waste collection system of claim 1 wherein the plurality of container bodies are each supported by a plurality of wheels.

8. The waste collection system of claim 7 wherein the base includes a plurality of panels spaced apart to define the plurality of bays therebetween, the plurality of panels each including a flared portion below which at least some of the plurality of wheels are received when the plurality of container bodies are received in the plurality of bays.

9. The waste collection system of claim 8 wherein the plurality of panels each includes a groove formed therein and wherein the plurality of container bodies each include a lip receivable in one of the plurality of grooves.

10. The waste collection system of claim 7 wherein each of the plurality of container bodies includes a side wall extending upward from a base wall, the side wall defining an upper opening to the container body, a main lid pivotably secured to the side wall to selectively cover the upper opening to the container body.

11. The waste collection system of claim 10 further including a gravity lock bar pivotably secured to the base and pivotable between a locked position on the main lids and an unlocked position away from the main lids.

12. The waste collection system of claim 10 wherein each of the plurality of container bodies includes a grab bar and an upper attachment envelope secured to the side wall.

13. The waste collection system of claim 9 further including a rotatable latch secured to at least one of the plurality of panels and configured to secure at least one of the plurality of container bodies in the base.

14. A waste collection base comprising:
a plurality of panels spaced apart to define a plurality of bays therebetween, wherein two of the plurality of panels have a fork tine opening defined therein, wherein each of the plurality of bays is configured to receive a container body therein, wherein the plurality of panels are configured to receive the container bodies through front openings to the plurality of bays and to interlock with the plurality of container bodies to retain the plurality of container bodies in the plurality of bays when the waste container collection base is inverted.

15. The waste collection base of claim 14 further including a plurality of wheels supporting the plurality of panels.

16. The waste collection base of claim 14 further including at least one connector bar connecting the plurality of panels.

17. The waste collection base of claim 14 wherein the two of the plurality of panels are a pair of outer panels, the plurality of panels further including a pair of inner panels between the pair of outer panels.

18. The waste collection base of claim 17 further including at least one metal bar connecting the pair of outer panels to the pair of inner panels.

19. The waste collection base of claim 14 wherein the plurality of panels each include interlocking portions configured to interlock with a container body.

20. The waste collection base of claim 14 further including a rotatable latch secured to at least one of the plurality of panels and configured to secure at least one of the plurality of container bodies in the base.

21. A waste collection cartridge comprising:
a container body including a side wall extending upward from a base wall, the side wall defining an upper opening to the container body;
a main lid pivotably secured over the upper opening; and
interlocking portions for interlocking with a base and retaining the cartridge in the base when inverted.

22. The waste collection cartridge of claim 21 wherein the interlocking portions include a plurality of wheels positioned outward of the side wall.

23. The waste collection cartridge of claim 21 wherein the interlocking portions include a lip projecting outward of the side wall.

24. The waste collection cartridge of claim 21 further including a grab bar and an upper attachment envelope on a front end of the side wall.

25. The waste collection cartridge of claim 21 further include a sub-lid hingeably secured to the main lid over an opening through the main lid.

26. A method for using a waste collection system including:
placing waste in each of a plurality of container bodies;
rolling each of the plurality of container bodies into one of a plurality of bays in a base;
securing the plurality of container bodies in the base; and
inverting the base and the plurality of container bodies to empty the waste from the plurality of container bodies.
